(19) United States
(12) Patent Application Publication
(10) Pub. No.: US 2024/0415164 A1
(43) Pub. Date: Dec. 19, 2024

(54) Automated Beverage Production Device and Automatic Tapioca Pearl Extrusion Machine

(71) Applicant: CHIEN-JUNG CHU, Kaohsiung City (TW)

(72) Inventors: CHIEN-JUNG CHU, Kaohsiung City (TW); CHANG-HSI WU, Kaohsiung City (TW); SHENG-WEI TU, Kaohsiung City (TW)

(21) Appl. No.: 18/677,842

(22) Filed: May 29, 2024

(30) Foreign Application Priority Data
Jun. 15, 2023 (TW) 112122492

(51) Int. Cl. A23P 30/20; A47J 31/46

(52) U.S. Cl. CPC A23P 30/20; A47J 31/46; A23V 2002/00

(57) ABSTRACT

Automated beverage production device designed to add a predetermined amount of tapioca pearls to a beverage cup is provided and includes automatic tapioca pearl extrusion machine, weight sensing module, and microcontroller. The automatic tapioca pearl extrusion machine includes motor, motor shaft, main housing, and conical casing. One end of the motor shaft is rotatably connected to the motor, and the other end is connected to an extrusion block. The main housing includes an accommodation space where the extrusion block is located, with the extrusion block's cross-sectional shape corresponding to that of the accommodation space. The conical casing covers the bottom of the main housing and features multiple through-holes. The beverage cup is placed on the weight sensing module, and the microcontroller is electrically connected to the motor and the weight sensing module. The tapioca pearls are positioned within the accommodation space, situated between the extrusion block and the conical casing.

### FIELD OF THE DISCLOSURE

The present invention relates to an automated beverage production device and an automatic tapioca pearl extrusion machine, particularly to such devices incorporating motors and conical casings.

### BACKGROUND OF THE INVENTION

The revenue of beverage shops has grown rapidly in recent years, making it an industry that cannot be ignored. This growth is attributed not only to the expansion of bubble tea and coffee shop locations but also to the introduction of innovative beverage flavors. Additionally, the entry of e-commerce delivery services into the market has further boosted the growth of the beverage industry. Against this backdrop, beverage shop operators have begun to employ automated equipment for producing hand-shaken drinks to enhance production quality, ensure product consistency, and reduce labor costs. This automation is essential for the continued growth and success of the industry.

However, fully automating the production of drinks containing additives, such as the appropriate amount of tapioca pearls in bubble tea, poses challenges. Tapioca pearls tend to stick together if they remain in one place for too long, forming dense clumps. This results in uneven distribution within the beverage cup, degrading the texture and flavor experience of consuming the pearls. Moreover, traditional methods relying on manual scooping of tapioca pearls often fail to control the quantity precisely, affecting the quality and taste of the drinks.

Thus, there is a need within the industry to improve these issues by ensuring an even distribution of tapioca pearls within beverage cups and precisely controlling the amount of pearls used.

### SUMMARY OF THE INVENTION

The objective of the present invention is to provide an automated beverage production device capable of uniformly distributing tapioca pearls within a beverage cup and precisely controlling the quantity of tapioca pearls used.

The automated beverage production device of this invention is designed for adding a suitable amount of tapioca pearls to a beverage cup. The device includes an automatic tapioca pearl extrusion machine, a weight sensing module, and a microcontroller. The automatic tapioca pearl extrusion machine comprises a motor, a motor shaft, a main housing, and a conical casing. One end of the motor shaft is rotatably connected to the motor, and the other end is connected to an extrusion block. The main housing includes an accommodation space where the extrusion block is situated, with the extrusion block's cross-sectional shape corresponding to that of the accommodation space. The conical casing covers the bottom of the main housing and is equipped with multiple through-holes. Additionally, the beverage cup is placed on the weight sensing module, and the microcontroller is electrically connected to both the motor and the weight sensing module. The tapioca pearls are positioned within the accommodation space, between the extrusion block and the conical casing.

In this beverage production device, each through-hole's cross-sectional area in the conical casing decreases from the inner wall to the outer wall. The multiple through-holes are positioned near the tip of the conical casing. The motor is a linear stepper motor, and the main housing is made of a transparent material.

Another objective of the invention is to provide an automatic tapioca pearl extrusion machine that ensures the even distribution of tapioca pearls within the beverage cup. The automatic tapioca pearl extrusion machine includes a motor, a motor shaft, an extrusion block, a main housing, and a conical casing. The motor shaft is rotatably connected to the motor at one end and connected to the extrusion block at the other. The main housing contains an accommodation space where the extrusion block is located, and the conical casing, covering the bottom of the main housing, has multiple through-holes. The cross-sectional shape of the extrusion block corresponds to that of the accommodation space. In this extrusion machine, the aperture of each through-hole gradually decreases from the inner wall to the outer wall of the conical casing. The multiple through-holes are located near the tip of the conical casing. The motor is a linear stepper motor, and the main housing is made of a transparent material.

The invention offers the advantage of ensuring a uniform distribution of tapioca pearls in the beverage cup, with precise control over the quantity of pearls required for each beverage, enhancing both efficiency and consistency in beverage preparation.

### BRIEF DESCRIPTION OF THE DRAWINGS

The accompanying drawings, which are incorporated herein and form a part of the specification, illustrate the embodiments of the present invention and, together with the description, serve to explain the principles of the invention. The drawings are only for the purpose of illustrating preferred and alternative examples of how the invention can be made and used and are not to be construed as limiting the invention to only the illustrated and described examples. The various advantages and features of the present inventions will appear from a consideration of the drawings in which:

FIG. 1A is a schematic view of the automated beverage production device 10 according to the present embodiment.

FIG. 1B is a perspective view of the automatic tapioca pearl extrusion machine 12.

FIG. 1C is a cross-sectional view and a partial enlarged view of the automatic tapioca pearl extrusion machine 12.

FIGS. 2A and 2B are perspective views from different angles of the motor 121, motor shaft 122, and extrusion block 123.

FIGS. 3A and 3B are schematic views illustrating the extrusion of tapioca pearls 7 by the extrusion block 123.

FIG. 3C shows an automatic tapioca pearl extrusion machine 12′ suitable for horizontal placement.

FIG. 4 is a schematic view showing the positional relationship between the automatic tapioca pearl extrusion machine 12, the beverage cup 8, and the weight sensing module 13.

### DESCRIPTION OF THE PREFERRED EMBODIMENTS

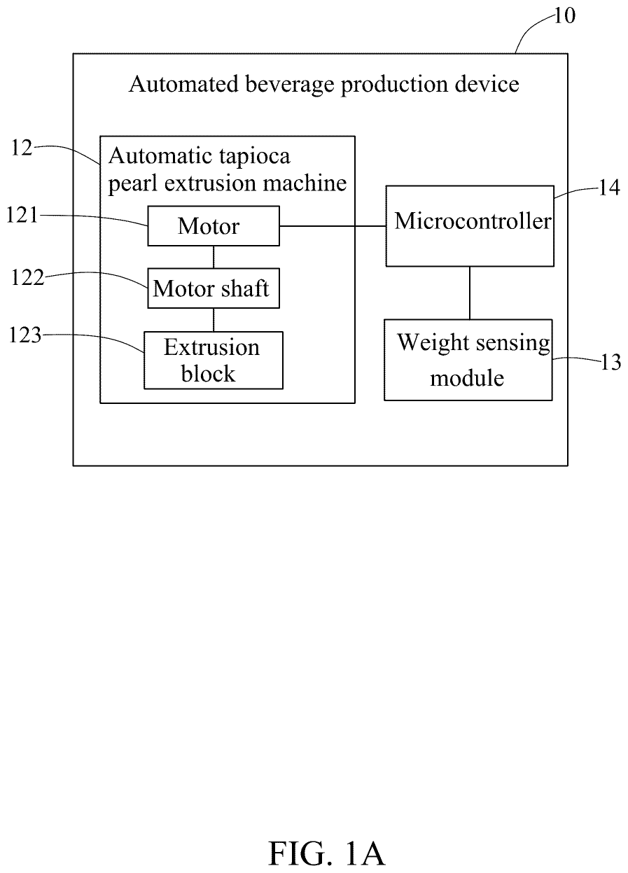

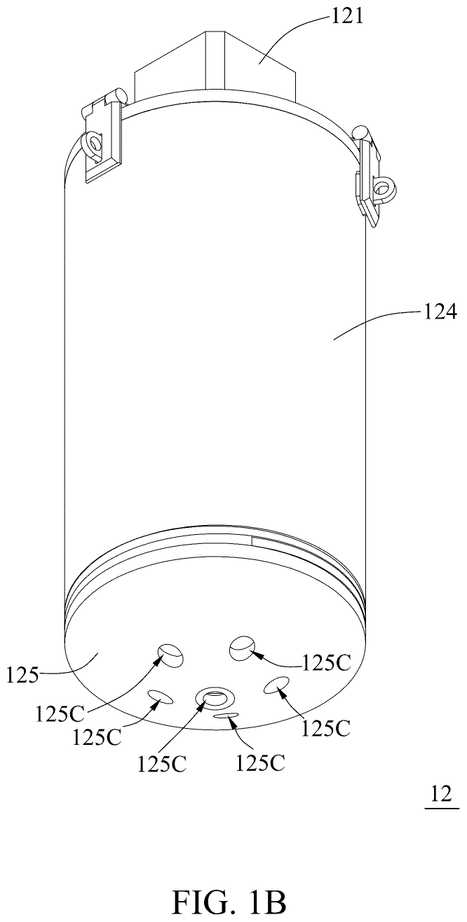

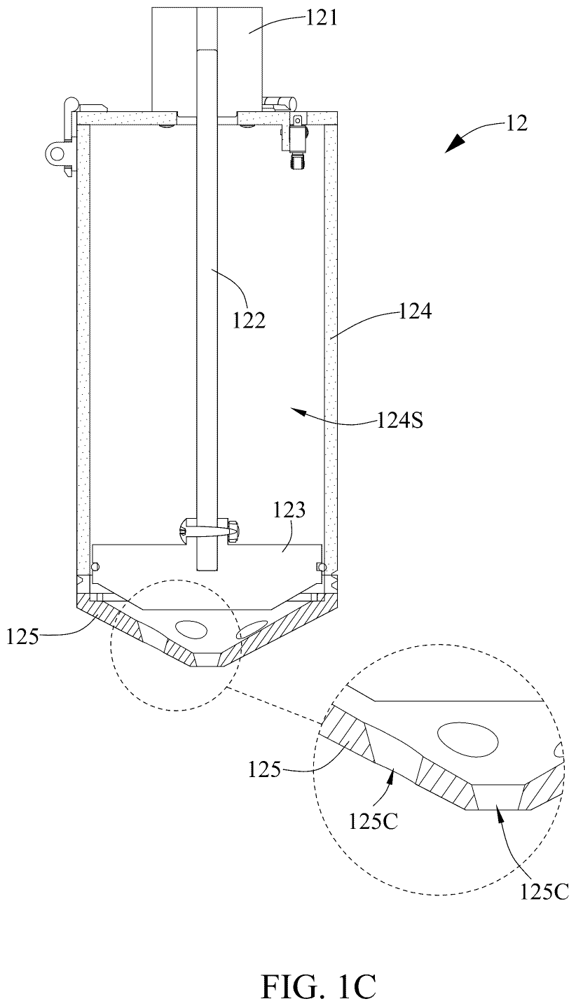

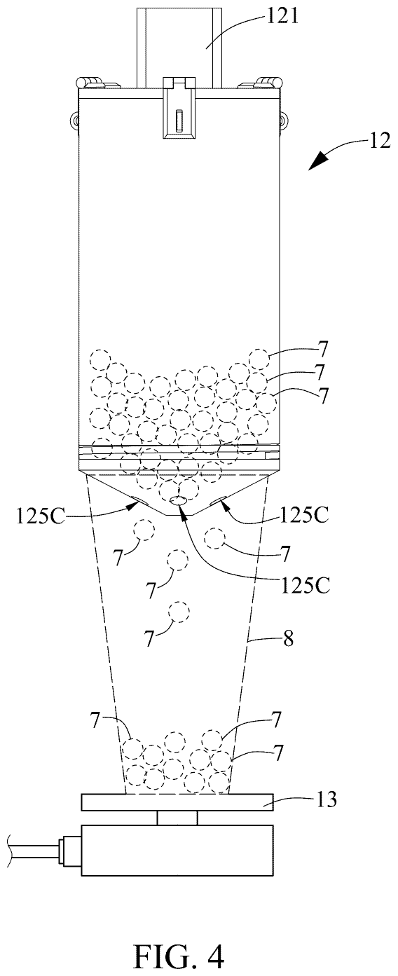

Referencing FIGS. 1A to 1C, FIG. 1A illustrates a schematic view of the automated beverage production device 10 according to the present embodiment. FIG. 1B presents a perspective view of the automatic tapioca pearl extrusion machine 12, and FIG. 1C shows a cross-sectional and a partial enlarged view of the same machine. The automated beverage production device 10 is designed to add an appropriate amount of tapioca pearls 7 to a beverage cup 8 (see FIG. 4 for initial reference). The device comprises an automatic tapioca pearl extrusion machine 12, a weight sensing module 13, and a microcontroller 14. The automatic tapioca pearl extrusion machine 12 includes a motor 121, a motor shaft 122, an extrusion block 123, a main housing 124, and a conical casing 125. The motor 121 is positioned above the main housing 124, and the conical casing 125 covers the bottom of the main housing 124.

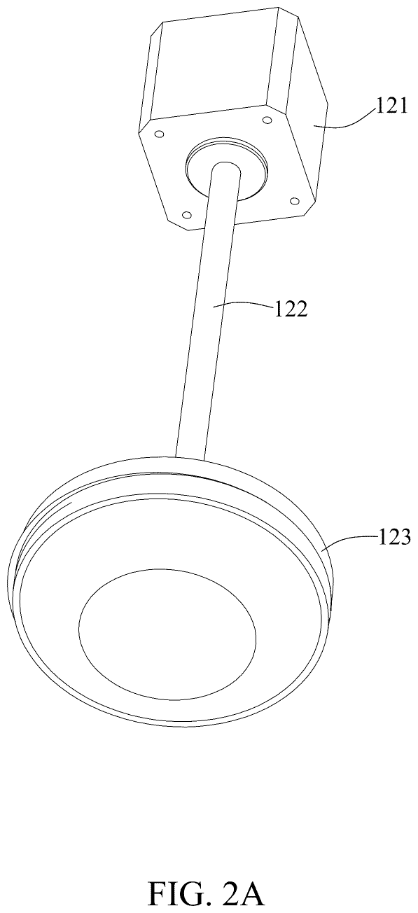

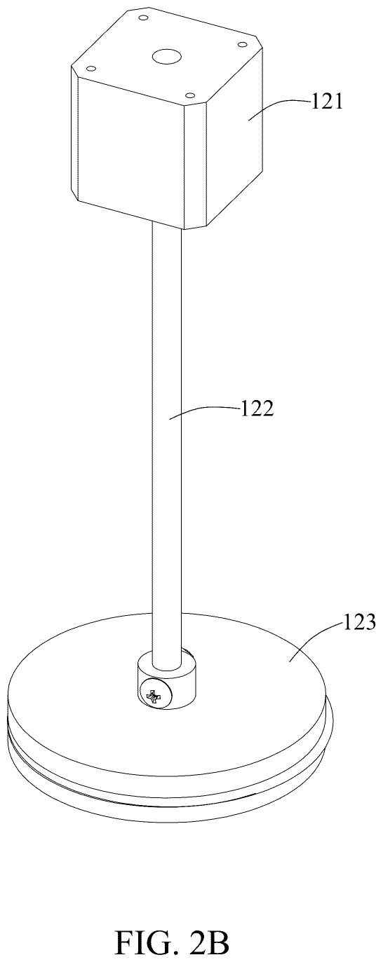

Also refer to FIGS. 2A and 2B, where one end of the motor shaft 122 is rotatably connected to the motor 121, and the other end connects to the extrusion block 123. Further referring back to FIG. 1C, the main housing 124 is equipped with an accommodation space 124S, within which the extrusion block 123 is located. In this embodiment, the cross-sectional shape of the extrusion block 123 corresponds to the shape of the accommodation space 124S. Specifically, the perimeter of the extrusion block 123 almost touches the inner walls of the main housing 124, effectively dividing the accommodation space 124S into two compartments.

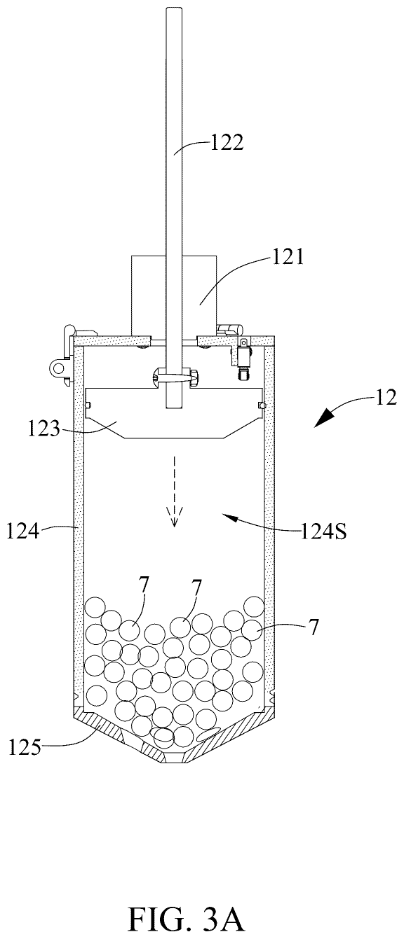

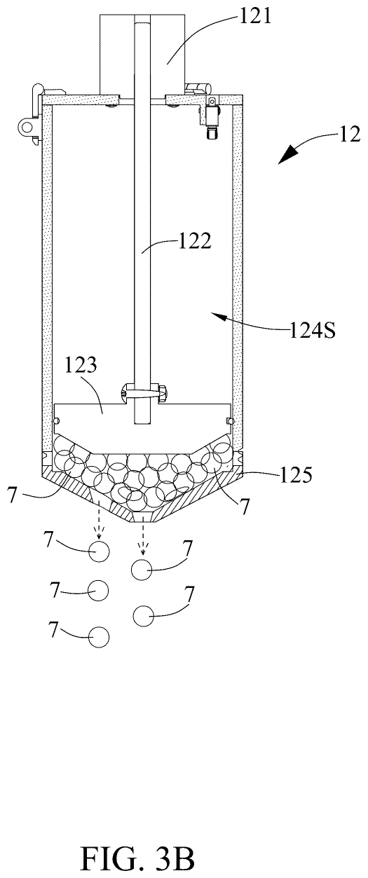

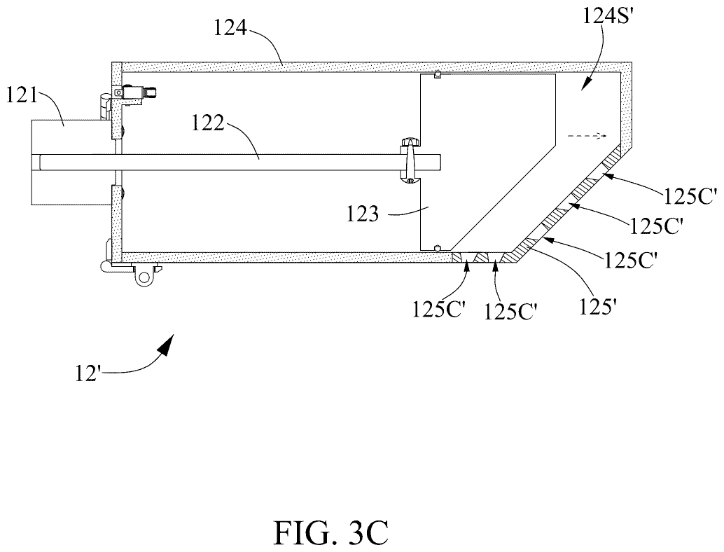

Additionally, FIGS. 3A and 3B depict schematic illustrations of the extrusion block 123 compressing the tapioca pearls 7. The tapioca pearls 7 to be distributed are placed within the accommodation space 124S of the main housing 124. More specifically, the pearls 7 are located between the extrusion block 123 and the conical casing 125.

Moreover, the motor 121 is a critical component of the automatic tapioca pearl extrusion machine 12 and is exemplified by a linear stepper motor. Specifically, the motor 121 converts digital pulses into mechanical shaft rotations, enabling fine control over the position and speed of the motor shaft 122. This precise control facilitates the vertical movement of the extrusion block 123 within the the accommodation space 124S. Consequently, the extrusion block 123 applies downward pressure on the tapioca pearls 7 awaiting distribution, pushing them towards the conical casing 125 at the bottom. When the motor 121 is configured as a linear stepper motor, there is no rotational movement of the motor shaft 122 and the extrusion block 123. This design advantage ensures that no energy is wasted on the rotation of the motor shaft 122; instead, all the power is dedicated to the linear movement of the motor shaft 122 and the extrusion block 123, thus enhancing efficiency. Referring again to FIG. 1C, the conical casing 125 is equipped with six through-holes 125C. In this embodiment, each through-hole 125C has a cross-sectional area that gradually decreases from the inner wall to the outer wall of the conical casing, forming small conical holes. This configuration allows the tapioca pearls 7 awaiting distribution to flow smoothly through the through-holes 125C. Such a design ensures unimpeded flow of pearls within the automatic tapioca pearl extrusion machine 12, preventing the motor 121 from stalling due to blocked movement of the pearls.

Additionally, referring to FIG. 3B, if the tapioca pearls 7 awaiting distribution have formed into dense clumps, these clumps will be broken down into individual pearls as they pass through the through-holes 125C. This design significantly aids in ensuring a uniform distribution of tapioca pearls 7 within the beverage cup 8, thus enhancing the overall texture and taste of the beverage. In this embodiment, there are six through-holes 125C. However, in other embodiments, the number of through-holes 125C could be greater or fewer than six, also facilitating the uniform distribution of pearls within beverage cup 8.

Furthermore, while this embodiment illustrates the use of tapioca pearls 7 made from cassava starch, it should be noted that the automatic tapioca pearl extrusion machine 12 is not limited to commercially available tapioca pearls. In fact, the machine is adaptable for use with any edible granular materials, thereby broadening its scope of application.

Additionally, please refer to FIG. 3C, which illustrates an automatic tapioca pearl extrusion machine 12′ suitable for horizontal placement. The difference between the automatic tapioca pearl extrusion machine 12 and the automatic tapioca pearl extrusion machine 12′ lies in the orientation of the conical casing 125′. In the automatic tapioca pearl extrusion machine 12′, the conical casing 125′ is biased towards one side of the main body, which results in the fewer through-holes 125C′ also being located on the side of the main body. Moreover, the accommodation space 124S′ in the automatic tapioca pearl extrusion machine 12′ has a cross-sectional area that gradually decreases from the end near motor 121 towards the end near conical casing 125′. This design ensures that, even in a horizontal orientation, the automatic tapioca pearl extrusion machine 12′ can successfully extrude the tapioca pearls 7 outward.

Refer to FIGS. 1B and 4; FIG. 4 illustrates the positional relationship between the automatic tapioca pearl extrusion machine 12, the beverage cup 8, and the weight sensing module 13. In this embodiment, each through-hole 125C is strategically positioned near the tip of the conical casing 125. This unique design helps to prevent the expelled tapioca pearls 7 from accidentally falling outside the beverage cup 8 or sticking to the rim of the cup, ensuring that the pearls accurately enter into the beverage cup 8.

In the described embodiment, the main housing 124 is made from a transparent material such as acrylic or polycarbonate (PC). This clear design not only allows users to easily observe the process of distributing tapioca pearls 7 into the beverage cup 8 but also enhances the visual appeal of the device, improving user interaction. Refer to FIGS. 1A and 4, the microcontroller 14 is electrically connected to the motor 121 and the weight sensing module 13 of the automatic tapioca pearl extrusion machine 12. In this embodiment, the microcontroller 14 is electrically linked to both the motor 121 and the weight sensing module 13. The primary function of the microcontroller 14 is to precisely control the operation of motor 121 based on the weight of the beverage cup 8 detected by the weight sensing module 13. Specifically, when the beverage cup 8 is placed on the weight sensing module 13, the module begins to play a crucial role in ensuring the appropriate amount of the tapioca pearls 7 is dispensed into the cup 8. It continuously monitors the weight changes of the beverage cup 8 and generates corresponding weight data. Microcontroller 14 receives and processes this weight data from the weight sensing module 13 and controls the operation of motor 121 accordingly to precisely extrude the correct amount of the tapioca pearls 7 into the beverage cup 8. Therefore, compared to traditional manual scooping methods, the automated beverage production device 10 of this invention offers a more efficient and accurate way to insert the precise amount of the tapioca pearls 7 into beverage cup 8. This innovative approach not only enhances the efficiency of preparing hand-shaken beverages but also ensures the quality and taste of each drink.

Additionally, the structural features of the automated beverage production device 10 in this embodiment can be further referred to in the published literature, such as patent number TWI737553, titled “Intelligent Energy-Saving Automatic Beverage Adjusting Equipment and Intelligent Beverage Automatic Dispensing Method.” In this description, we have primarily disclosed the technical features and components related to this case, while more detailed structures of the automated beverage production device 10 can be referenced in patent number TWI737553, as it provides a more detailed and extensive disclosure of the technical features.

In summary, the automated beverage production device 10 of the present invention can uniformly distribute tapioca pearls within the beverage cup and precisely control the quantity of tapioca pearls required for hand-shaken beverages.

Although the present invention has been disclosed above in terms of preferred embodiments, they are not intended to limit the present invention. Anyone with ordinary skill in the art may make slight changes and modifications without departing from the spirit and scope of the present invention. Therefore, the scope of protection of the present invention shall be determined by the appended patent application scope.

1. An automated beverage production device for adding a predetermined amount of tapioca pearls to a beverage cup, comprising:
an automatic tapioca pearl extrusion machine including:
a motor;
a motor shaft, one end of which is rotatably connected to the motor;
an extrusion block, connected to the other end of the motor shaft;
a main housing, having an accommodation space wherein the extrusion block is located, and the extrusion block's cross-sectional shape corresponds to that of the accommodation space;
a conical casing, covering the bottom of the main housing and having a plurality of through-holes;
a weight sensing module on which the beverage cup is placed; and
a microcontroller, electrically connected to the motor and the weight sensing module;
wherein the tapioca pearls are positioned between the extrusion block and the conical casing.

2. The automated beverage production device of claim 1, wherein each through-hole in the conical casing has a cross-sectional area that gradually decreases from the inner wall to the outer wall of the conical casing.

3. The automated beverage production device of claim 1, wherein the multiple through-holes are located near the tip of the conical casing.

4. The automated beverage production device of claim 1, wherein the motor is a linear stepper motor.

5. The automated beverage production device of claim 1, wherein the main housing is made of a transparent material.

6. An automatic tapioca pearl extrusion machine, comprising:
a motor;
a motor shaft, one end of which is rotatably connected to the motor;
an extrusion block, connected to the other end of the motor shaft;
a main housing, having an accommodation space wherein the extrusion block is located; and
a conical casing, covering the bottom of the main housing and having multiple through-holes;
wherein the extrusion block's cross-sectional shape corresponds to that of the accommodation space.

7. The automatic tapioca pearl extrusion machine of claim 6, wherein each through-hole in the conical casing has a cross-sectional area that decreases from the inner wall to the outer wall of the conical casing.

8. The automatic tapioca pearl extrusion machine of claim 6, wherein the multiple through-holes are located near the tip of the conical casing.

9. The automatic tapioca pearl extrusion machine of claim 6, wherein the motor is a linear stepper motor.

10. The automatic tapioca pearl extrusion machine of claim 6, wherein the main housing is made of a transparent material.
